(19) United States
(12) Patent Application Publication
(10) Pub. No.: US 2023/0402212 A1
(43) Pub. Date: Dec. 14, 2023

(54) TRANSFORMER CORE

(71) Applicant: HITACHI ENERGY SWITZERLAND AG, Baden (CH)

(72) Inventors: Jigar TANK, Ahmedabad (IN); Abhay AGRAWAL, Vadodara (IN)

(21) Appl. No.: 18/034,567

(22) PCT Filed: Nov. 26, 2021
(86) PCT No.: PCT/EP2021/083167

§ 371 Date: Apr. 28, 2023

(30) Foreign Application Priority Data
Nov. 26, 2020 (IN) 202021022057

(51) Int. Cl. H01F 3/02; H01F 27/26; H01F 41/02

(52) U.S. Cl. CPC H01F 3/02; H01F 27/263; H01F 41/0233

(57) ABSTRACT

At least one lamination layer of a transformer core includes a first side limb component, a second side limb component, an upper yoke component including one or more upper yoke segments, a lower yoke component including one or more lower yoke segments, and an intermediate limb component including a first intermediate limb segment and a second intermediate limb segment. The upper yoke component is disposed in between an upper end of the first and second side limb component, the lower yoke component is disposed in between a lower end of the first and second side limb component, and a first end and a second end of the intermediate limb component is disposed in between two consecutive upper yoke segments and two consecutive lower yoke segments, respectively, where at least one of the upper yoke segment and the lower yoke segment is trapezoidal in structure.

### CROSS REFERENCE TO RELATED APPLICATIONS

This application is a 35 U.S.C. § 371 national stage application of PCT International Application No. PCT/EP2021/083167 filed on Nov. 26, 2021, which in turn claims priority to Indian Application No. 202021022057, filed on Nov. 26, 2020, the disclosures and content of which are incorporated by reference herein in their entirety.

### TECHNICAL FIELD

The present subject matter relates a transformer core and a method of assembling a transformer core.

### BACKGROUND

Transformers are electrical devices that transfer electrical energy from one electrical circuit to another. Transformers include a magnetic core on which windings are wound or interleaved for the transfer of electrical energy. In general, vertical portions of the transformer core on which windings are wound are referred to as legs or limbs of the transformer and the horizontal portions of the transformer core that connect or support the limbs are referred to as a yoke of the transformer. In order to minimize core losses, also referred to as iron losses, such as eddy current losses and hysteresis losses, the transformer core is made of laminated sheets of metal or metal alloys. Multiple lamination sheets, made of materials, such as high-grade silicon steel, that are insulated from one another with materials, such as varnish, are stacked together to form a laminated transformer core. Generally, the yoke and limbs are separately cut from lamination sheets and then assembled to form a lamination layer. The lamination layers are then stacked and assembled to form the transformer core.

### SUMMARY

Embodiments of the present disclosure provide a transformer core and methods to form the transformer core. Objectives of embodiments of the disclosure include reducing or eliminating design scrap generated when forming the transformer and providing a transformer core with a high mechanical strength with reduced design scrap. The embodiments of the present subject matter address the problems associated with forming a transformer core with a conventional lamination layer assembly, thereby eliminating design scrap, reducing the iron losses, increasing the ease of yoke filling, and providing the transformer core with a higher mechanical strength.

According to a first aspect, a transformer core is provided. The transformer core includes a plurality of lamination layers. At least one lamination layer of the plurality of lamination layers includes a first side limb component, a second side limb component, an upper yoke component including one or more upper yoke segments, a lower yoke component including one or more lower yoke segments, and an intermediate limb component comprising a first intermediate limb segment and a second intermediate limb segment. The upper yoke component is disposed in between an upper end of the first side limb component and an upper end of the second side limb component, the lower yoke component is disposed in between a lower end of the first side limb component and a lower end of the second side limb component, and a first end of the intermediate limb component is disposed in between two consecutive upper yoke segments and a second end of the intermediate limb component is disposed in between two consecutive lower yoke segments, where at least one of the upper yoke segment and the lower yoke segment is trapezoidal in structure.

According to an implementation, the upper yoke component comprises a plurality of upper yoke segments and the lower yoke component comprises a plurality of lower yoke segments, where the first diagonal edge of each of the plurality of upper yoke segments makes a first upper yoke angle with a base of the corresponding upper yoke segment, where the first upper yoke angle ranges between 55 degrees to 70 degrees and the second diagonal edge of each of the plurality of upper yoke segments makes a second upper yoke angle with a base of the corresponding upper yoke segment, where the second upper yoke angle is a 45-degree angle. Similarly, the first diagonal edge of each of the plurality of lower yoke segments makes a first lower yoke angle with a base of the corresponding lower yoke segment, where the first lower yoke angle ranges between 55 degrees to 70 degrees and the second diagonal edge of each of the plurality of lower yoke segments makes a second lower yoke angle with a base of the corresponding lower yoke segment, where the second lower yoke angle is a 45-degree angle.

According to an implementation a first slanting edge of the first intermediate limb segment of the intermediate limb component is adjoined to a first diagonal edge of a first upper yoke segment and a first slanting edge of the second intermediate limb segment of the intermediate limb component is adjoined to a first diagonal edge of a second upper yoke segment at a first end of the intermediate limb component. Similarly, a second slanting edge of the first intermediate limb segment of the intermediate limb component is adjoined to a first diagonal edge of a first lower yoke segment and a second slanting edge of the second intermediate limb segment of the intermediate limb component is adjoined to a first diagonal edge of a second lower yoke segment at a second end of the intermediate limb component. Further, a first abutting edge of the first side limb component is adjoined to a second diagonal edge of the first upper yoke segment at an upper end of the first side limb component and a second abutting edge of first side limb component is adjoined to a second diagonal edge of the first lower yoke segment at a lower end of the first side limb component. Similarly, a first abutting edge of the second side limb component is adjoined to a second diagonal edge of the second upper yoke segment at an upper end of the second side limb component and a second abutting edge of the second side limb component is adjoined to a second diagonal edge of the second lower yoke segment at a lower end of the second side limb component.

According to an implementation a length of the base of the first intermediate limb segment and the second intermediate limb segment of the intermediate limb component is equal to a length of a base of the first side limb component and a length of a base of the second side limb component, wherein each of the first intermediate limb segment, second intermediate limb segment, first side limb component, and second side limb component are trapezoidal in structure.

According to an implementation, the first intermediate limb segment and the second intermediate limb segment are adjoined along respective bases to form the intermediate limb component.

According to an implementation, two consecutive lamination layers of the plurality of lamination layers are stacked with a predetermined offset between adjacent layers to form a step-lap joint.

According to an implementation, lengths of a first lower yoke segment and a second lower yoke segment of a lamination layer are respectively different from lengths of a successive first lower yoke segment and a successive second lower yoke segment of a successive lamination layer.

According to an implementation, widths of the first intermediate limb segment and the second intermediate limb segment of the intermediate limb component of a lamination layer are respectively different from widths of a successive first intermediate limb segment and a successive second intermediate limb segment of the intermediate limb component of a successive lamination layer.

According to an implementation, the first slanting edge and the second slanting edge of the first intermediate limb segment makes a first intermediate angle and a second intermediate angle with the base of the first intermediate limb segment, respectively, where the first intermediate angle and the second intermediate angle ranges between 20 degrees to 35 degrees. Similarly, the first slanting edge and the second slanting edge of the second intermediate limb segment makes a first intermediate angle and a second intermediate angle with the base of the second intermediate limb segment, respectively, where the first intermediate angle and the second intermediate angle ranges between 20 degrees to 35 degrees.

According to a second aspect, a method for forming a lamination layer of a transformer core is provided. The method includes obtaining a first side limb component, obtaining a second side limb component, cutting a first lamination strip to obtain a plurality of upper yoke segments that are trapezoidal in structure to form an upper yoke component, where the plurality of the upper yoke segments are cut consecutively from the first lamination strip as alternate upright and inverted trapezoids, cutting a second lamination strip to obtain a plurality of lower yoke segments that are trapezoidal in structure to form a lower yoke component, where the plurality of the lower yoke segments are cut consecutively from the second lamination strip as alternate upright and inverted trapezoids, and forming an intermediate limb component from a first intermediate limb segment and a second intermediate limb segment. The upper yoke component is disposed between an upper end of the first side limb component and an upper end of the second side limb component, the lower yoke component is disposed between a lower end of the first side limb component and a lower end of the second side limb component, and a first end of the intermediate limb component is disposed between two consecutive upper yoke segments and a second end of the intermediate limb component is disposed between two consecutive lower yoke segments. Further, the first side limb component, the second side limb component, the intermediate limb component, the upper yoke component, and the lower yoke component are joined to form a lamination layer of a transformer core.

According to an implementation, a third lamination strip is cut to obtain first intermediate limb segments and second intermediate limb segments that are trapezoidal in structure to form the intermediate limb component, where the first intermediate limb segments and the second intermediate limb segments are cut consecutively from the third lamination strip as alternate upright and inverted trapezoids.

According to an implementation, a first diagonal edge of each of the plurality of upper yoke segments makes a first upper yoke angle with a base of the corresponding upper yoke segment, where the first upper yoke angle is based on a length of the corresponding upper yoke segment, where the first upper yoke angle ranges between 55 degrees to 70 degrees; a second diagonal edge of each of the plurality of upper yoke segments makes a second upper yoke angle with a base of the corresponding upper yoke segment, wherein the second upper yoke angle is a 45-degree angle; a first diagonal edge of each of the plurality of lower yoke segments makes a first lower yoke angle with a base of the corresponding lower yoke segment, wherein the first lower yoke angle is based on a length of the corresponding lower yoke segment; ranges between 55 degrees to 70 degrees; and a second diagonal edge of each of the plurality of lower yoke segments makes a second lower yoke angle with a base of the corresponding lower yoke segment, wherein the second lower yoke angle is a 45-degree angle.

According to an implementation, a plurality of lamination layers are stacked to form the transformer core, wherein two consecutive lamination layers of the plurality of lamination layers are stacked with a predetermined offset between adjacent layers forming a step-lap joint.

According to an implementation, dimensions of the plurality of lower yoke segments and dimensions of the first intermediate limb segments and the second intermediate limb segments are a function of the predetermined offset.

According to an implementation, the method comprises forming a lamination layer of the transformer core by performing the following steps:
(i) adjoining the first intermediate limb segment and the second intermediate limb segment along a base of the first and second intermediate limb segment to form the intermediate limb component;
(ii) adjoining a first diagonal edge of a first upper yoke segment to a first slanting edge of the first intermediate limb segment of the intermediate limb component and adjoining a first diagonal edge of a second upper yoke segment to a first slanting edge of the second intermediate limb segment of the intermediate limb component at a first end of the intermediate limb component;
(iii) adjoining a first diagonal edge of a first lower yoke segment to a second slanting edge of the first intermediate limb segment of the intermediate limb component and adjoining a first diagonal edge of a second lower yoke segment to a second slanting edge of the second intermediate limb segment of the intermediate limb component at a second end of the intermediate limb component;
(iv) adjoining a first abutting edge of the first side limb component to a second diagonal edge of the first upper yoke segment at an upper end of the first side limb component and adjoining a second abutting edge of the first side limb component to a second diagonal edge of the first lower yoke segment at a lower end of the first side limb component; and
(v) adjoining a first abutting edge of the second side limb component to a second diagonal edge of the second upper yoke segment at an upper end of the second side limb component and adjoining a second abutting edge of the second side limb component to a second diagonal edge of the second lower yoke segment at a lower end of the second side limb component.

### BRIEF DESCRIPTION OF DRAWINGS

The features, aspects, and advantages of the present subject matter will be better understood with regard to the following description and accompanying figures. The use of the same reference number in different figures indicates similar or identical features and components.

FIG. 1(a) illustrates a layer of lamination of a conventional transformer core.

FIG. 1(b) depicts stacking of multiple lamination layers to form the conventional transformer core.

FIG. 1(c) illustrates a shape of each lamination portion used to form a lamination layer of the conventional transformer core.

FIG. 1(d) illustrates design scrap generated from the yoke and the central limb lamination portion of a conventional transformer core.

FIG. 2 illustrates a lamination layer of a transformer core, in accordance with an embodiment of the present subject matter.

FIG. 3 illustrates stacking of multiple lamination layers to form a transformer core, in accordance with an embodiment of the present subject matter.

FIG. 4(a) illustrates an upper yoke segment and a first lamination strip to cut upper yoke segments, in in accordance with an embodiment of the present subject matter.

FIG. 4(b) illustrates a second lamination strip and a plurality of lower yoke segments cut from the second lamination strip, in accordance with an embodiment of the present subject matter.

FIG. 4(c) illustrates a third lamination strip and an intermediate limb segment of the intermediate limb component cut from the third lamination strip, in accordance with an embodiment of the present subject matter.

FIG. 4(d) illustrates a fourth lamination strip and a side limb component cut from the fourth lamination strip, in accordance with an embodiment of the present subject matter

FIG. 5 illustrates a transformer core stacking pattern, in accordance with an embodiment of the present subject matter.

FIG. 6 illustrates an example method for forming a transformer core, in accordance with an embodiment of the present subject matter.

### DETAILED DESCRIPTION

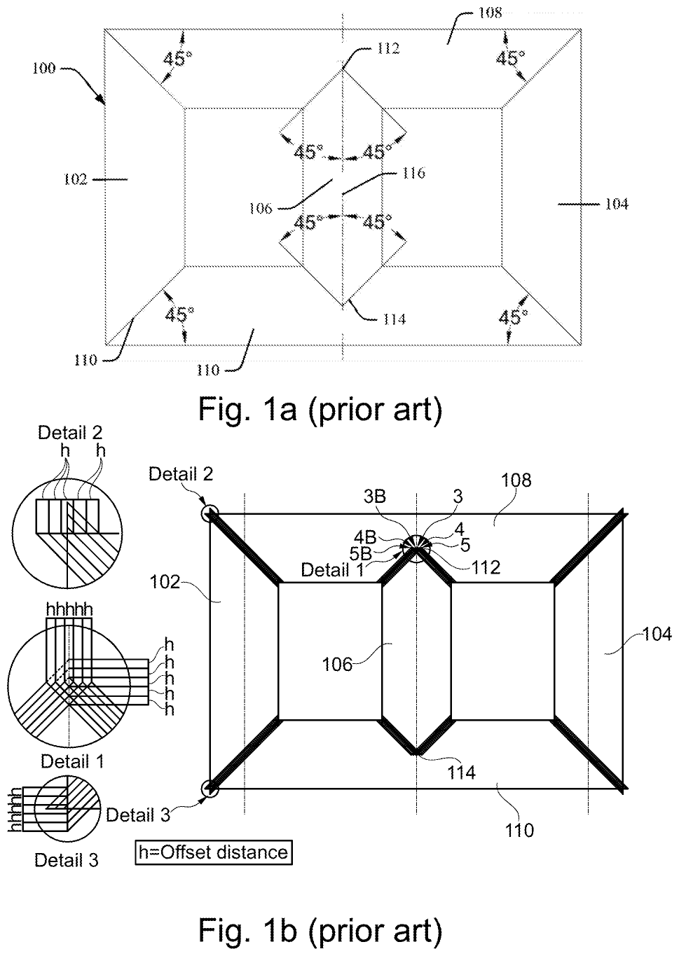

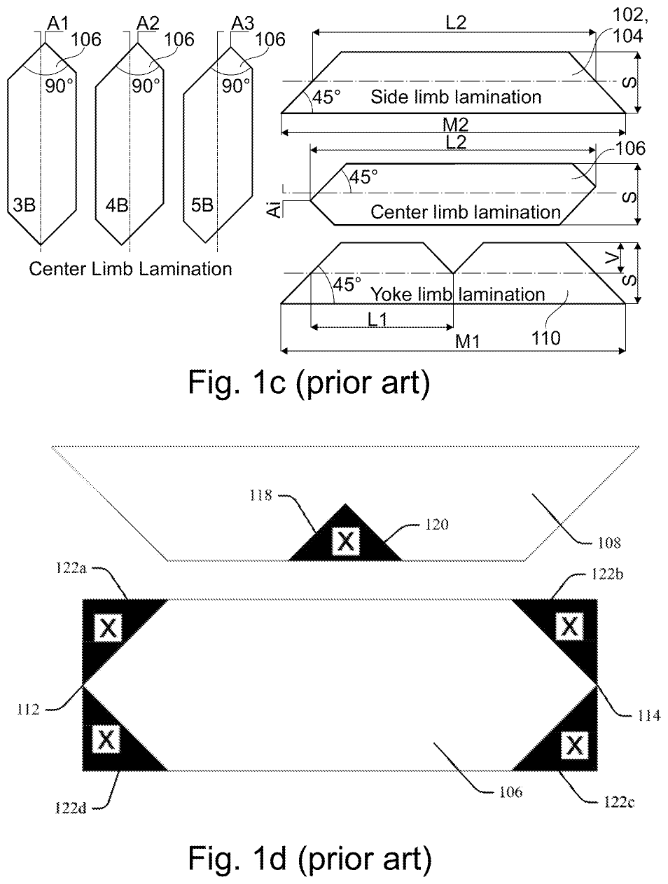

The present subject matter relates to a transformer core and methods to form the transformer core. Conventionally, in case of power and distribution transformers produced with stacked cores, core sheets are overlapped at corners to form overlapping joints. These overlapping joints, also referred to as mitered joints, can be a normal-lap joint or a step-lap joint. In a step-lap joint, lamination sequences are provided with steps by offsetting the successive layers of lamination with predefined offset. Each layer of lamination is made by arranging the constituent components together and the lamination layers are stacked adjacent to each other as shown in FIGS. 1(a) and 1(b). An example of the step lap arrangement with six steps is illustrated in the FIG. 1(b), which is the most commonly used arrangement. Conventional methods of lamination layer positioning and stacking with overlapping scheme and shape of a lamination layer for a three phase-three limb transformer core, also referred to as a T core or a 3P3C core with six steps are illustrated in the FIGS. 1(a) to 1(c). In one conventional arrangement, one layer of lamination for a three-limb core transformer is made of two yoke components and three limb components.

FIG. 1(a) illustrates a lamination layer 100 of a conventional transformer core. The lamination layer 100 includes a first side limb lamination portion 102, a second side limb lamination portion 104, a central limb lamination portion 106, an upper yoke lamination portion 108, and a lower yoke lamination portion 110. In order to form the lamination layer 100 of a three-limb transformer core, the first side limb lamination portion 102, the central limb lamination portion 106, and the second side limb lamination portion 104 are positioned parallel to one another and assembled in between the upper yoke lamination portion 108 and the lower yoke lamination portion 110. The first side limb lamination portion 102 is connected between one end of the upper yoke lamination portion 108 and one end of the lower yoke lamination portion 110, where the first side limb lamination portion 102 is substantially perpendicular to the upper yoke lamination portion 108 and the lower yoke lamination portion 110. Similarly, the second side limb lamination portion 104 is connected between another end of the upper yoke lamination portion 108 and another end of the lower yoke lamination portion 110, where the second limb lamination portion is substantially perpendicular to the upper yoke lamination portion 108 and the lower yoke lamination portion 110.

As depicted in FIG. 1(a), the central limb lamination portion 106 has a first triangular end 112 at one end which is to be connected to the upper yoke lamination portion 108 and a second triangular end 114 at another end that is to be connected to the lower yoke lamination portion 110. The central limb lamination portion 106 is formed by cutting the first triangular end 112 and the second triangular end 114, such that each edge of the first triangular end 112 and the second triangular end 114 makes a 45-degree angle with respect to a central axis 116 of the central limb lamination portion 106. In order to connect the first triangular end 112 to the upper yoke lamination portion 108 and the second triangular end 114 to the lower yoke lamination portion 110, a V-notch is cut in the upper and lower yoke lamination portions. Multiple lamination layers such as the lamination layer 100 are stacked to form the transformer core as shown in FIG. 1(b). FIG. 1(b) depicts stacking of multiple lamination layers to form the conventional three limb transformer core. A step-lap arrangement with six steps is shown, where successive lamination layers are offset with a pre-defined distance marked as “h” as illustrated in details A, B, and C.

FIG. 1(c) illustrates a shape of each lamination portion that forms the conventional transformer core. Lamination size detailing is marked in FIG. 1(c) as an example. While the first and second side limb lamination portions can be cut from a lamination sheet without any design scrap, however, the central limb lamination portion 106, the upper yoke lamination portion 108, and the lower yoke lamination portion 110 have a portion of material that is to be discarded as indicated in FIG. 1(d). To produce the V-notch 118 in the upper yoke lamination portion 108 and the lower yoke lamination portion 110, respectively, a portion of the lamination strip 120 is cut in a triangular form and discarded to accommodate the triangular ends of the central limb lamination portion 106. Similarly, in order to form the first triangular end 112 and the second triangular end 114 of the central limb lamination portion 106, four corners 122a, 122b, 122c, and 122d of the lamination strip material as shown in FIG. 1(d) are cut and discarded. The material which is removed from a lamination strip to form the upper yoke lamination portion 108, the lower yoke lamination portion 110, and the central limb lamination portion 106 is referred to as design scrap. As can be observed from FIGS. 1(c) and 1(d), design scrap cannot be avoided in the conventional method used to form the lamination layer 100. Generally, the design scrap is approximately 3% to 6% of the total core weight, which depends on the core size including the limb height, limb pitch, limb diameter, and the like. Cutting a lamination strip material to form the central limb lamination portion 106, the upper, and lower yoke lamination portion contributes to the design scrap.

In order to alleviate problems associated with the conventional methods associated with cutting and assembling a lamination layer of a transformer core, the present subject matter provides multiple upper and lower yoke segments that are trapezoidal in structure and an intermediate limb component with two segments. Such structure of the yoke and central limb helps to avoid the design scrap that is otherwise generated, as discussed above. The intermediate limb is split into two parts i.e., the intermediate limb is manufactured as two separate segments such that each segment can be cut separately without any wastage. The length of the intermediate limb component is kept the same as that of the side limb components and hence, no notch may be required to be provided in the yoke components. Further, the upper and lower yoke components are split into multiple segments that are trapezoidal in structure, such that the ends of the intermediate limb extend to the upper and lower ends of the yoke segments to eliminate the need of the V-notch which was contributing to the design scrap in conventional methods of manufacturing the lamination layer to form the transformer core. Rather, the intermediate limb component is joined to the yoke segments along the sides of the intermediate limb component for high mechanical strength.

Accordingly, the present subject matter provides a transformer core that includes a plurality of lamination layers. At least one lamination layer of the plurality of lamination layers includes a first side limb component, a second side limb component, an upper yoke component including a plurality of upper yoke segments, a lower yoke component including a plurality of lower yoke segments, and an intermediate limb component comprising a first intermediate limb segment and a second intermediate limb segment. The upper yoke component is disposed in between an upper end of the first side limb component and an upper end of the second side limb component, the lower yoke component is disposed in between a lower end of the first side limb component and a lower end of the second side limb component, and a first end of the intermediate limb component is disposed in between two consecutive upper yoke segments and a second end of the intermediate limb component is disposed in between two consecutive lower yoke segments.

The present subject matter thus helps to eliminate design scrap by providing a lamination layer with multiple upper yoke segments, lower yoke segments and at least two segments forming the intermediate limb of the transformer core and also provides a transformer core with high mechanical strength.

The above and other features, aspects, and advantages of the subject matter will be better explained with regard to the following description and accompanying figures. Wherever possible, the same reference numbers are used in the drawings and the following description to refer to the same or similar parts. While several examples are described, modifications, adaptations, and other implementations are possible.

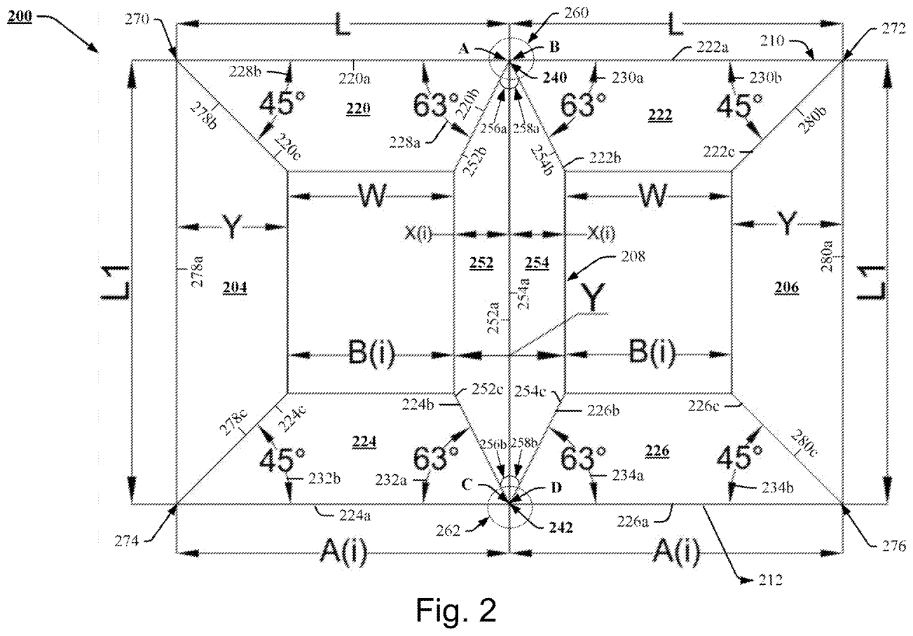

FIG. 2 illustrates a lamination layer 200 of the transformer core, in accordance with an embodiment of the present subject matter. A plurality of lamination layers, such as the lamination layer 200, may be stacked to form a three-limb transformer core, alternatively referred to as transformer core. In one example, a plurality of components of the lamination layer 200 may be cut out from one or more lamination strips. The plurality of components that are cut out from the lamination strips include a first side limb component 204, a second side limb component 206, an intermediate limb component 208, an upper yoke component 210 including multiple upper yoke segments, and a lower yoke component 212 including multiple lower yoke segments. The plurality of components is assembled together to form the lamination layer 200. In one example, the components of the lamination layer 200 are trapezoidal in structure or made of segments that are trapezoidal in structure.

For the sake of simplicity, the structure and assembly of one lamination layer 200 of the plurality of lamination layers of a three-limb transformer core is discussed. However, similar principles may be applied for forming the successive lamination layers to form the three-limb transformer core, or for forming lamination layers to form a transformer core with a higher number of limbs. It will also be understood that the angles shown in the figures are merely examples and the actual angles would depend on the relative dimensions of the different components forming the transformer core.

In one example, to assemble the lamination layer 200 of the transformer core, the first side limb component 204, the intermediate limb component 208, and the second side limb component 206, collectively referred to as the limb components may be positioned parallel to one another, such that the intermediate limb component 208 may be positioned in between the first side limb component 204 and the second side limb component 206. The three limb components are disposed in between the upper yoke component 210 and the lower yoke component 212.

In one example, the upper yoke component 210 may include multiple upper yoke segments that may be adjoined along their corners to one another, in order to form the upper yoke component 210, where each upper yoke segment may be trapezoidal in structure. Similarly, the lower yoke component 212 may include multiple lower yoke segments that may be adjoined to one another along their corners, to form the lower yoke component 212, where each of the lower yoke segments may be trapezoidal in structure. In one example, multiple upper and lower yoke segments are respectively cut from a first lamination strip and a second lamination strip as consecutive alternate upright and inverted trapezoids.

In one example, a first upper yoke corner ‘A’ of a first upper yoke segment 220 may be adjacently connected to a first upper yoke corner ‘B’ of a second upper yoke segment 222 to form the upper yoke component 210 and a first lower yoke corner ‘C’ of a first lower yoke segment 224 may be adjacently connected to a first lower yoke corner ‘D’ of a second lower yoke segment 226 to form the lower yoke component 212. The first upper yoke segment 220 includes a base 220a, a first diagonal edge 220b, and a second diagonal edge 220c. The second upper yoke segment 222 includes a base 222a, a first diagonal edge 222b, and a second diagonal edge 222c. Similarly, a first lower yoke segment 224 includes a base 224a, a first diagonal edge 224b, and a second diagonal edge 224c. The a second lower yoke segment 226 includes a base 226a, a first diagonal edge 226b, and a second diagonal edge 226c.

In one example, the first upper yoke segment 220 may be formed by cutting the first lamination strip into a trapezoidal structure such that the first diagonal edge 220b of the first upper yoke segment 220 makes a first upper yoke angle 228a with the base 220a of the first upper yoke segment 220 and the second diagonal edge 220c of the first upper yoke segment 220 makes a second upper yoke angle 228b with the base 220a of the first upper yoke segment 220. Similarly, the second upper yoke segment 222 may be formed by cutting the first lamination strip into a trapezoidal structure such that the first diagonal edge 222b of the second upper yoke segment 222 makes a first upper yoke angle 230a with the base 222a of the second upper yoke segment 222 and the second diagonal edge 222c of the second upper yoke segment 222 makes a second upper yoke angle 230b with the base 222a of the second upper yoke segment 222. In one example, the first upper yoke angle 228a, 230a of the first and second upper yoke angle, respectively, may range between 55 degrees to 70 degrees. In one example, the upper yoke angles may each be 63 degrees. Further, in one example the second upper yoke angle 228b, 230b of the first and second upper yoke segment, respectively, may be a 45-degree angle.

Similarly, the first lower yoke segment 224 may be formed by cutting the second lamination strip into a trapezoidal structure such that the first diagonal edge 224b of the first lower yoke segment 224 makes a first lower yoke angle 232a with the base 224a of the first lower yoke segment 224 and the second diagonal edge 224c of the first lower yoke segment 224 makes a second lower yoke angle 232b with the base 224a of the first upper yoke segment 220. Similarly, the second lower yoke segment 226 may be formed by cutting the second lamination strip into a trapezoidal structure such that the first diagonal edge 226b of the second lower yoke segment 226 makes a first lower yoke angle 234a with the base 226a of the second lower yoke segment 226 and the second diagonal edge 226c of the second lower yoke segment 226 makes a second lower yoke angle 234b with the base 226a of the second lower yoke segment 226. In one example, the first lower yoke angle 232a, 234a of the first and second lower yoke angle, respectively, may range between 55 degrees to 70 degrees. In one example, the lower yoke angles may each be 63 degrees. Further, in one example the second lower yoke angle 232b, 234b of the first and second lower yoke segment, respectively, may be a 45-degree angle.

In one example, a first end 240 of the intermediate limb component 208 may be disposed in between two consecutive upper yoke segments, i.e., between the first upper yoke corner ‘A’ of the first upper yoke segment 220 and the first upper yoke corner ‘B’ of the second upper yoke segment 222. Similarly, the second end 242 of the intermediate limb component 208 may be disposed in between two consecutive lower yoke segments, i.e., between the first lower yoke corner ‘C’ of the first lower yoke segment 222a and the first lower yoke corner ‘D’ of the second lower yoke segment 222b. The intermediate limb component 208 includes a first intermediate limb segment 252 and a second intermediate limb segment 254. The first intermediate limb segment 252 includes a base 252a, a first slanting edge 252b and a second slanting edge 252c. Similarly, the second intermediate limb segment 254 includes a base 254a, a first slanting edge 254b, and a second slanting edge 254c. In one example, each segment of the intermediate limb component 208 may be formed by cutting a third lamination strip such that the first slanting edge 252b and the second slanting edge 252c of the first intermediate limb segment 252 makes a first intermediate angle 256a and a second intermediate angle 256b with the base 252a of the first intermediate limb segment 252, respectively. Similarly, the first slanting edge 254b and the second slanting edge 254c of the second intermediate limb segment 254 makes a first intermediate angle 258a and a second intermediate angle 258b with the base 254a of the second intermediate limb segment 254, respectively. In one example, the first intermediate angle 256a, 258a and the second intermediate angle 256b, 258b may vary based on a length of the upper and lower yoke segment, respectively. In one example, first intermediate angle 256a, 258a and the second intermediate angle 256b, 258b may lie in the range of 20 degrees to 35 degrees.

The base 252a of the first intermediate limb segment 252 and the base 254a of the second intermediate limb segment 254 may be adjoined to form the intermediate limb component 208. Subsequently, the first slanting edge 252b of the first intermediate limb segment 252 may be adjoined to the first diagonal edge 220b of the first upper yoke segment 220 and the first slanting edge 254b of the second intermediate limb segment 254 may be adjoined to the first diagonal edge 222b of the second upper yoke segment 222 at the first end 240 of the intermediate limb component 208. Similarly, the second slanting edge 252c of the first intermediate limb segment 252 may be adjoined to the first diagonal edge 224b of the first lower yoke segment 224 and the second slanting edge 254c of the second intermediate limb segment 254 may be adjoined to the first diagonal edge 226b of the second lower yoke segment 226 at the second end 242 of the intermediate limb component 208. Thus, the first end 240 of the intermediate limb component 208 may be joined in between two consecutive corners A and B of the upper yoke segments and the second end 242 of the intermediate limb component 208 may be joined in between two consecutive corners C and D of the lower yoke segments.

The first end 240 of the intermediate limb component 208 forms a T-joint 260 with the upper yoke component 210 and the second end 216 of the intermediate limb component 208 forms a T-joint 262 with the lower yoke component 212. To form the T-joint 260, 262 at the first end and the second end of the intermediate limb component 208 and the upper and lower yoke components, respectively, a sum of the first intermediate angle 256a of the first intermediate limb segment 252 and the first upper yoke angle 228a of the first upper yoke segment 220 may be 90-degrees. For example, when the first upper yoke angle 228a is a 55-degree angle, the first intermediate angle 256a may be a 35 degrees angle. Similarly, when the first upper yoke angle 228a is a 63-degree angle, the first intermediate angle 256a may be a 27-degree angle. The same principle may be applicable for the first upper yoke angle 228a ranging between 55-degrees to 70 degrees. Forming the T-joint of the transformer core with the upper yoke segments having the first upper yoke angle in the range of 55-degrees to 70 degrees decreases the no load losses of the transformer.

Further, the upper yoke component 210 may be disposed in between an upper end 270 of the first side limb component 204 and an upper end 272 of the second side limb component 206 and the lower yoke component 212 may be disposed in between a lower end 274 of the first side limb component 204 and a lower end 276 of the second side limb component 206. The first side limb component 204 may include a base 278a, a first abutting edge 278b, and a second abutting edge 278. Similarly, the second side limb component 206 may include a base 280a, a first abutting edge 280b, and a second abutting edge 280c. In one example, the first side limb component 204 and the second side limb component 206 may be cut from a fourth lamination strip, such that the first and second side angles of the first and second side limb components respectively make 45-degrees with a base of the first and second side limb component.

In one example, the first abutting edge 278b of the first side limb component 204 may be adjoined to the second diagonal edge 220c of the first upper yoke segment 220 at the upper end 270 of the first side limb component 204 and the second abutting edge 278c of first side limb component 204 may be adjoined to the second diagonal edge 224c of the first lower yoke segment 224 at the lower end 274 of the first side limb component 204. Similarly, the first abutting edge 280b of the second side limb component 206 may be adjoined to the second diagonal edge 222c of the second upper yoke segment 222 at the upper end 272 of the second side limb component 206 and the second abutting edge 280c of the second side limb component 206 may be adjoined to the second diagonal edge 226c of the second lower yoke segment 226 at the lower end 276 of the second side limb component 206 to form the lamination layer 200.

In one example, a length (L1) of the base 278a of the first side limb component 204 and a length (L1) of the base 280a of the second side limb component 206 may be equal to a length of the base 252a of the first intermediate limb segment 252 and a length of the base 254a of the second intermediate limb segment 254 of the intermediate limb component 208, due to which cutting a V-notch in the upper yoke component 210 and the lower yoke component 212 may be completely eliminated.

Therefore, zero/minimum design scrap may be generated on cutting lamination strips to obtain the various constituents of a lamination layer 200, such as multiple upper and lower yoke segments, and the first and second intermediate limb segment of the intermediate limb component, that are trapezoidal in structure, irrespective of the size of the transformer core.

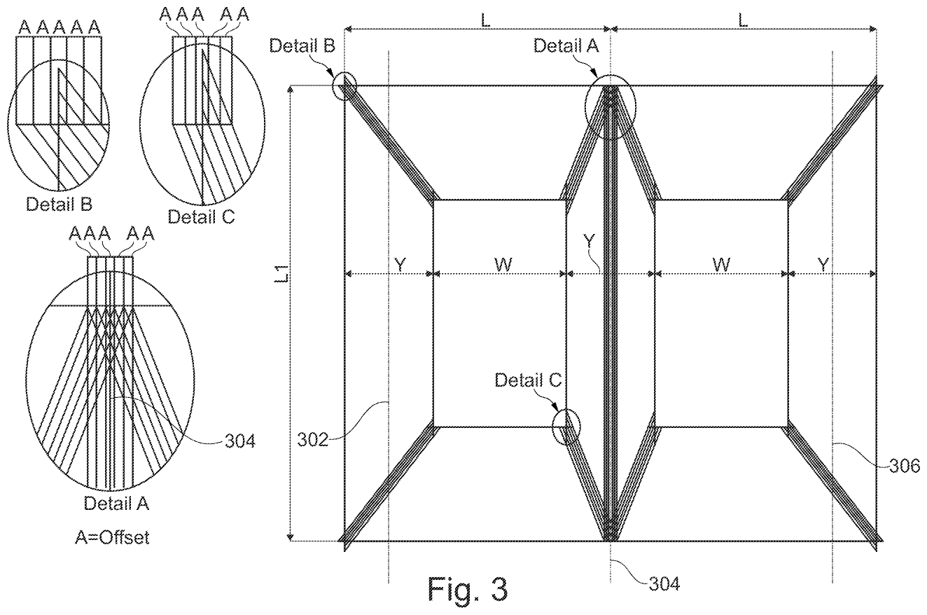

FIG. 3 illustrates stacking of multiple lamination layers to form the transformer core, in accordance with an embodiment of the present subject matter. In one example, the transformer core with a step-joint may be assembled by stacking multiple lamination layers with a pre-defined offset between two consecutive lamination layers of the transformer core. In one example, the step-lap may be obtained by shifting subsequent first side limb components, intermediate limb components, and the second side limb components of the lamination layers by the predetermined offset value along a vertical direction with respect to a central axis of the first side limb component 302, a central axis of the intermediate limb component 304, and a central axis of the second side limb component 306, collectively referred to as a central axis of the limb components, respectively. In one example, each subsequent lamination layer may be shifted with respect to the central axis of the limb components by placing three lamination layers to the left of the central axis of the limb components and placing three lamination layers to the right of the central axis of the limb components in order to form the step lap joint. A detailed view of the step-joints formed between the upper yoke component and the first and second side limb components is illustrated in detail A, a detailed view of the step-joints formed between the lower yoke component and the first and second side limb components is illustrated in detail B, and a detailed view of the T-joint formed between the upper and lower yoke components and the first end and second end of the intermediate limb component is illustrated in detail C, where ‘A’ is the predetermined offset. In one example, the predetermined offset may be set to 9 mm.

From FIG. 3, it may be observed that a length of two upper yoke segments of a lamination layer may be the same as the length of two upper yoke segments of a successive lamination layer. However, lengths of a lower yoke segment of a lamination layer may be different from lengths of a successive lower yoke of a successive lamination layer and the widths of the first and second intermediate limb segments of a lamination layer are respectively different from widths of a successive first and second intermediate limb segment of a successive lamination layer to enable forming the step-lap joint. For a stacked lamination core, a particular width of lamination strip may be taken for forming particular components and the lamination strip can be cut into trapezoids at specified angle (for example, 63°), for zero design scrap manufacturing.

Further, successive lamination layers being sufficiently overlapped forming the step-lap at corners and T-joint at intermediate portions of the transformer core result in increasing the mechanical strength of the joints formed and decreasing the no-load losses when the lamination strips are cut in angles in the range of 55 degrees to 70 degrees to form the T joint.

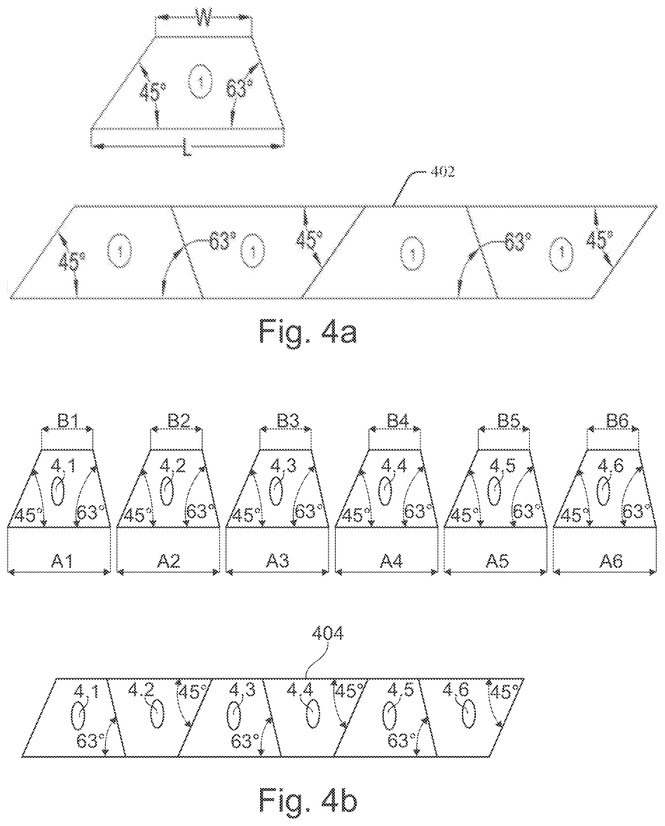

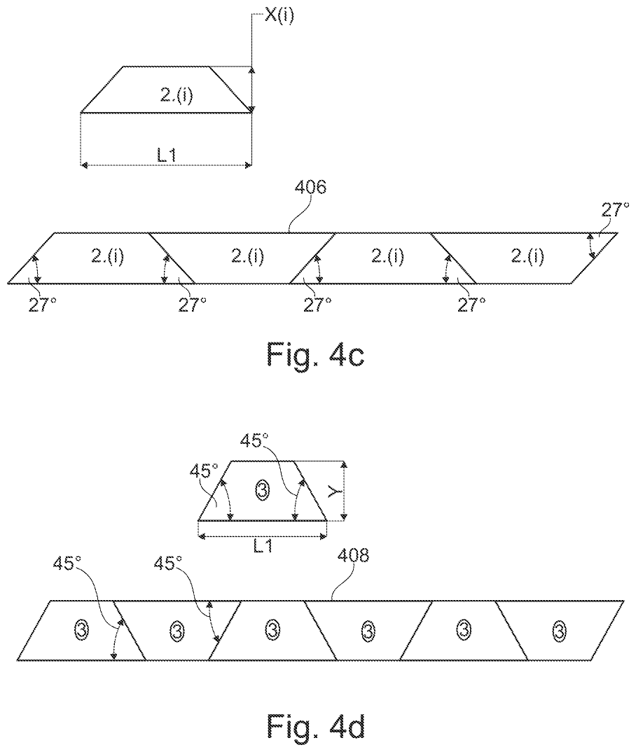

FIG. 4(a) illustrates an upper yoke segment and a first lamination strip 402 to cut upper yoke segments, in accordance with an embodiment of the present subject matter. In one example, the first lamination strip 402 may be cut consecutively at the second upper yoke angle and the first upper yoke angle after a preset length L which forms the base of the corresponding upper yoke segment forming alternate upright and inverted trapezoids to obtain the multiple upper yoke segments. In one example, the second upper yoke angle may be a 45-degree angle and the first upper yoke angle may lie in the range of 55-degrees to 70 degrees. In one example, the first upper yoke angle may be a 63-degree angle. In one example, all the upper yoke segments of a lamination layer may have the same dimension as the upper yoke segments of a successive lamination layer. The same sequence may be repeated until a last upper yoke segment is cut out for a predefined width of lamination. In one example, as two consecutive upper yoke segments are cut at the same first upper yoke angle and the second upper yoke angle, the first lamination strip may be cut in series, one after another without discarding material from the lamination strip as design scrap.

FIG. 4(b) illustrates a second lamination strip 404 and a plurality of lower yoke segments cut from the second lamination strip, in accordance with an embodiment of the present subject matter. In one example, lengths of a first lower yoke segment and a second lower yoke segment of a lamination layer may be respectively different from lengths of a successive first lower yoke segment and a successive second lower yoke segment of a successive lamination layer. In one example, dimensions of the plurality of lower yoke segments are a function of the predetermined offset. For example, six lower yoke segments of different lengths may be cut from a second lamination strip. A lower yoke segment 4.1 of a first length of the six lower yoke segments may be cut based on equations (1) and (2) as depicted below:

A1=L+(A) (1)

B1=W+(A) (2)

Where, A1 represents a length of the base of a lower yoke segment of the first length, B1 represents a length of an edge opposite to the base A1 of the lower yoke segment of the first length, L represents a length of an upper yoke segment of the lamination layer, A represents the predetermined offset, and W represents a length of an edge opposite to the base L of an upper yoke segment of the lamination layer. The dimensions L, W, and A are marked in FIG. 3. Similarly, lower yoke segments of different lengths may be computed. A lower yoke segment 4.2 of a second length of the six lower yoke segments may be cut based on equations (3) and (4) as depicted below:

A2=L+(3*A) (3)

B2=W+(3*A) (4)

Where, A2 represents a length of the base of a lower yoke segment of the second length, B2 represents a length of an edge opposite to the base A2 of the lower yoke segment, L represents a length of an upper yoke segment of the lamination layer, A represents the predetermined offset, and W represents a length of an edge opposite to the base L of an upper yoke segment of the lamination layer. A lower yoke segment 4.3 of a third length of the six lower yoke segments may be cut based on equations (5) and (6) as depicted below:

A3=L+(5*A) (5)

B3=W+(5*A) (6)

Where, A3 represents a length of the base of a lower yoke segment of the third length, B3 represents a length of an edge opposite to the base A3 of the lower yoke segment, L represents a length of an upper yoke segment of the lamination layer, A represents the predetermined offset, and W represents a length of an edge opposite to the base L of an upper yoke segment of the lamination layer. A lower yoke segment 4.4 of a fourth length of the six lower yoke segments may be cut based on equations (7) and (8) as depicted below:

A4=L−(A) (7)

B4=W−(A) (8)

Where, A4 represents a length of the base of the lower yoke segment of the fourth length, B4 represents a length of an edge opposite to the base A4 of the lower yoke segment, L represents a length of an upper yoke segment of the lamination layer, A represents the predetermined offset, and W represents a length of an edge opposite to the base L of an upper yoke segment of the lamination layer. A lower yoke segment 4.5 of a fifth length of the six lower yoke segments may be cut based on equations (9) and (10) as depicted below:

A5=L−(3*A) (9)

B5=W−(3*A) (10)

Where, A5 represents a length of the base of the lower yoke segment of the fifth length, B5 represents a length of an edge opposite to the base A5 of the lower yoke segment, L represents a length of an upper yoke segment of the lamination layer, A represents the predetermined offset, and W represents a length of an edge opposite to the base L of an upper yoke segment of the lamination layer. A lower yoke segment 4.6 of a sixth length of the six lower yoke segments may be cut based on equations (11) and (12) as depicted below:

A6=L−(5*A) (11)

B6=W−(5*A) (12)

Where, A6 represents a length of the base of the lower yoke segment of the sixth length, B6 represents a length of an edge opposite to the base A6 of the lower yoke segment, L represents a length of an upper yoke segment of the lamination layer, A represents the predetermined offset, and W represents a length of an edge opposite to the base L of an upper yoke segment of the lamination layer.

Further, in one example, to cut out the lower yoke segments from the second lamination strip, a first cut may be made to form the second diagonal edge at the second lower yoke angle with respect to the base of the corresponding lower yoke segment and a second cut may be made at the first lower yoke after a specific length A(i), set for the base of the lower yoke segment based on equations (1) to (12), where the value of (i) may vary from 1 to 6, such that the first diagonal edge is at an angle in the range of 55 degrees to 70 degrees with respect to the base of the corresponding lower yoke segment. In one example, the first lower yoke angle may be 63-degrees and the second lower yoke angle may be a 45-degree angle. The same sequence may be repeated until a last lower yoke segment is cut out for a predefined width of lamination. In one example, multiple lower yoke segments are cut consecutively from the second lamination strip as alternate upright and inverted trapezoids. As two consecutive lower yoke segments are cut at the same first lower yoke angle and the second lower yoke angle, the second lamination strip may be cut in series, one after another without discarding material from the lamination strip as design scrap. As depicted in the figure, lower yoke segments marked as 4.1, 4.2, 4.3, 4.4, 4.5 and 4.6 may be cut in the sequence with different length but at the alternating cutting angle of the second lower yoke angle and the first lower yoke angle. The following cutting sequence may be continued till all the desired quantity of laminations for a particular width are obtained. Alternatively, all lower yoke segments for a first length of a desired quantity may be cut first before proceeding to cut lower yoke segments of a second length. For example, all lower yoke segments with the first length marked as 4.1 may be cut first before proceeding to cut all lower yoke segments marked as 4.2.

FIG. 4(c) illustrates a third lamination strip 406 and an intermediate limb segment of the intermediate limb component cut from the third lamination strip, in accordance with an embodiment of the present subject matter. In one example, widths of the first intermediate limb segment and the second intermediate limb segment of the intermediate limb component of a lamination layer are respectively different from widths of a successive first intermediate limb segment and a successive second intermediate limb segment of the intermediate limb component of a successive lamination layer. In one example, dimensions of the first intermediate limb segments and the second intermediate limb segments are a function of the predetermined offset. In one example, a third lamination strip 406 may be cut to obtain the first intermediate limb segment and the second intermediate limb segment that are trapezoidal in structure to form the intermediate limb component, where the first intermediate limb segments and the second intermediate limb segments are cut consecutively from the third lamination strip as alternate upright and inverted trapezoids. As depicted in the figure, the first intermediate limb segment and a second intermediate limb segment have the same cutting angle. For example, six first intermediate limb segments and second intermediate limb segments of different widths may be cut from the third lamination strip. In one example, the first and second intermediate limb components of a first width 2.1, a second width 2.2, and a third width 2.3 may be computed as depicted in equation (13) below:

$$X ( i ) = \frac{Y}{2} + [ \{ ( i ) - 0.5 \} * Offset ] \qquad ( 13 )$$

Where X(i) represents a width of the first intermediate limb segments and the second intermediate limb segments cut for a first width, a second width, and a third width, where i=1 for a limb segment of the first width 2.1, i=2 for a limb segment of the second width 2.2, i=3 for a limb segment of the third width 2.3, offset represents the pre-determined offset, and Y represents a width of the first and second side limb component of the lamination layer as marked in FIG. 3. Similarly, the first and second intermediate limb components of a fourth width 2.4, a fifth width 2.5, and a sixth width 2.6 may be computed as depicted in equation (14) below:

$$X ( i ) = \frac{Y}{2} - [ \{ ( i ) - 3.5 \} * offset ] \qquad ( 14 )$$

Where X(i) represents a width of the first intermediate limb segments and the second intermediate limb segments cut for the fourth width, the second width, and the sixth width, where i=4 for a limb segment of the fourth width 2.4, i=5 for a limb segment of the fifth width 2.5, i=6 for a limb segment of the sixth width 2.6, offset represents the predetermined offset, and Y represents a width of the first and second side limb component of the lamination layer as marked in FIG. 3. In one example, the predefined offset may be 9 mm. To cut the first intermediate limb segment and the second intermediate limb segment from a third lamination strip, a first cut may be made to form the first intermediate angle with respect to the base of the corresponding first/second intermediate limb segment and a second cut may be made at the second intermediate angle after a specific length L1 of the base of the first/second intermediate limb segment, where the value of the first intermediate angle and the second intermediate angle may be in the range of 20-degrees to 35-degrees. In one example, the first and second intermediate angles may be a 27-degrees angle. The same sequence may be repeated until a last limb segment is cut out for a predefined width of lamination.

FIG. 4(d) illustrates a fourth lamination strip 408 and a side limb component cut from the fourth lamination strip 408, in accordance with an embodiment of the present subject matter. In one example, the fourth lamination strip 408 may be cut consecutively at a first side angle and a second side angle after a preset length L1 which forms the base of the first side limb component and the second side limb component forming alternate upright and inverted trapezoids to obtain the first side limb component and the second side limb component. In one example, the first side angle and the second side angle may be a 45-degree angle as depicted in the figure. The same sequence may be repeated until a last first side limb component and the second side limb component is cut out for a predefined width Y of the fourth lamination strip. As two consecutive side limb components are cut at the same first side angle and the second side angle, the fourth lamination strip may be cut in series, one after another without discarding material from the lamination strip as design scrap.

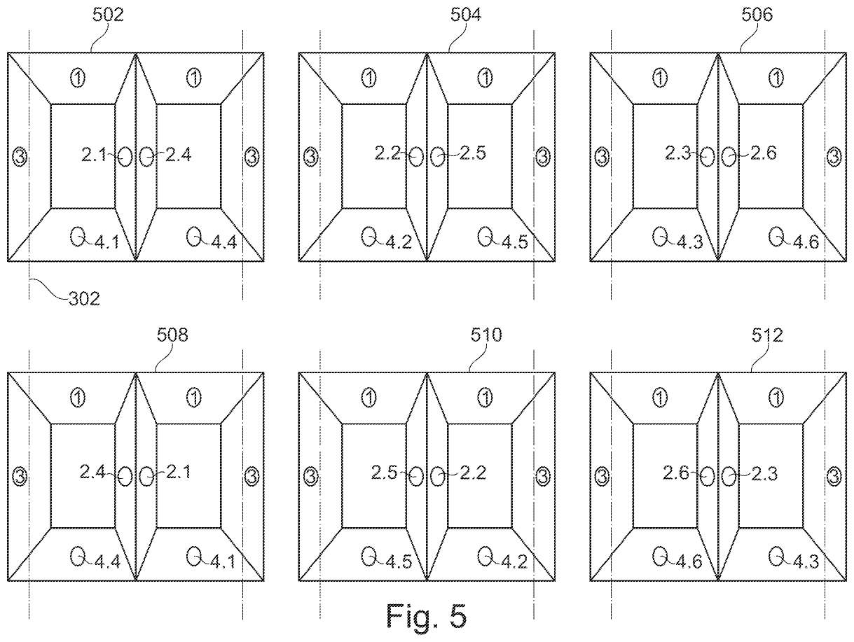

FIG. 5 illustrates a transformer core stacking pattern, in accordance with an embodiment of the present subject matter. On obtaining the first side limb component, the second side limb component, the first and second intermediate limb segments forming the intermediate limb component, multiple upper segments to form the upper yoke component, and multiple lower yoke segments to form the lower yoke component, a stacked laminated core may be assembled. In one example, to construct the laminated core of the transformer, six lamination layers may be obtained.

The constituents of a first lamination layer 502 may be joined as depicted in the figure, where two upper yoke segments marked as ‘1’ are joined to form the upper yoke component, the first lower yoke segment of a first length 4.1 and the second lower yoke segment of a fourth length 4.4 are joined to form the lower yoke component. The upper yoke component is joined between the upper ends of the first and second side limb components marked as 3 and the lower yoke component is joined in between the lower ends of the first and second side limb component. Further, the first intermediate side limb segment of the first width 2.1 and the second intermediate side limb segment of the fourth width 2.4 are adjoined along their respective bases to form the intermediate limb component and is joined between two consecutive upper yoke segments at the first end and between two consecutive lower yoke segments at the second end to form a first lamination layer of the six lamination layers of the transformer core.

The upper yoke segments 1 and the first and second side limb components 3 of the successive lamination layers may be assembled as explained above and has not been reproduced hereinafter for the sake of brevity. However, as explained above, lengths of a lower yoke segment of a lamination layer may be different from lengths of a successive lower yoke of a successive lamination layer and the widths of the first and second intermediate limb segments of a lamination layer are respectively different from widths of a successive first and second intermediate limb segment of a successive lamination layer. Based on which, to form the second lamination layer 504, the first lower yoke segment of a second length 4.2 and the second lower yoke segment of a fifth length 4.5 are joined to form the lower yoke component and the first intermediate side limb segment of a second width 2.2 and the second intermediate side limb segment of a fifth width 2.5 are adjoined along their respective bases to form the intermediate limb component. Similarly, for the third lamination layer 506, the first lower yoke segment of a third length 4.3 and the second lower yoke segment of a sixth length 4.6 are joined to form the lower yoke component and the first intermediate side limb segment of a third width 2.3 and the second intermediate side limb segment of a sixth width 2.6 are adjoined along their respective bases to form the intermediate limb component. To form the fourth lamination layer 508 of the transformer core, the first lower yoke segment of the fourth length 4.4 and the second lower yoke segment of the first length 4.1 are joined to form the lower yoke component and the first intermediate side limb segment of the fourth second width 2.4 and the second intermediate side limb segment of the first width 2.1 are adjoined along their respective bases to form the intermediate limb component. To form the fifth lamination layer 510 of the transformer core, the first lower yoke segment of the fifth length 4.5 and the second lower yoke segment of the second length 4.2 are joined to form the lower yoke component and the first intermediate side limb segment of the fifth width 2.5 and the second intermediate side limb segment of the second width 2.2 are adjoined along their respective bases to form the intermediate limb component. To form the sixth lamination layer 512 of the transformer core, the first lower yoke segment of the sixth length 4.6 and the second lower yoke segment of the first length 4.1 are joined to form the lower yoke component and the first intermediate side limb segment of the sixth width 2.6 and the second intermediate side limb segment of the third width 2.3 are adjoined along their respective bases to form the intermediate limb component. In one example, three lamination layers of the six lamination layers may be stacked to the right of the central axis of the first limb 302 and three lamination layers may be stacked to the left of the central axis of the first side limb component 302 to form the laminated transformer core with a stepped-joint as shown in FIG. 3.

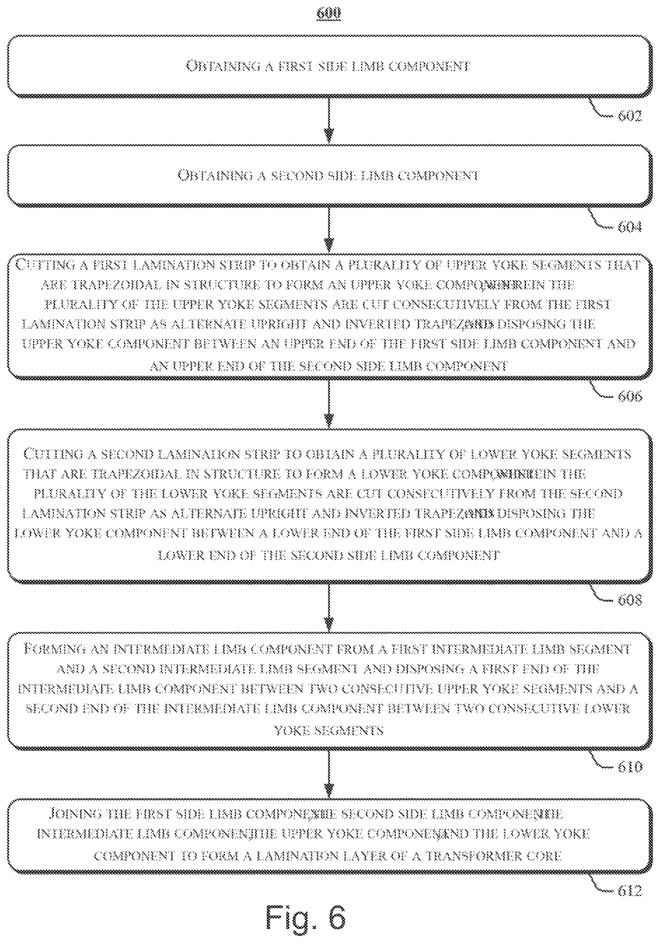

FIG. 6 illustrates an example method 600 for cutting and assembling a transformer core, in accordance with an embodiment of the present subject matter. The order in which the method 600 is described is not intended to be construed as a limitation, and any number of the described method blocks can be combined in any order to implement method 600 or an alternative method. Additionally, individual blocks may be deleted from the method 600 without departing from the spirit and scope of the subject matter described herein. Furthermore, the method 600 may be implemented in any suitable hardware, computer readable instructions, firmware, or combination thereof. For discussion, the method 600 is described with reference to the implementations illustrated in FIG.(s). 2-5

At block 602, a first side limb component of a lamination layer may be obtained.

At block 604, a second side limb component of a lamination layer may be obtained.

At block 606, a plurality of upper yoke segments that are trapezoidal in structure may be obtained by cutting a first lamination strip to form an upper yoke component. The upper yoke component may be disposed between an upper end of the first side limb component and an upper end of the second side limb component. In one example, the plurality of the upper yoke segments may be cut consecutively from the first lamination strip as alternate upright and inverted trapezoids.

At block 608, a plurality of lower yoke segments that are trapezoidal in structure may be obtained by cutting a second lamination strip to form a lower yoke component. The lower yoke component may be disposed between a lower end of the first side limb component and a lower end of the second side limb component. In one example, the plurality of the lower yoke segments may be cut consecutively from the second lamination strip as alternate upright and inverted trapezoids.

At block 610, a first intermediate limb segment and a second intermediate limb segment are obtained to form an intermediate limb component. In one example, a first end of the intermediate limb component may be disposed between two consecutive upper yoke segments and a second end of the intermediate limb component may be disposed in between two consecutive lower yoke segments. In one example, a third lamination strip may be cut to obtain first intermediate limb segments and second intermediate limb segments that are trapezoidal in structure to form the intermediate limb component, where the first intermediate limb segments and the second intermediate limb segments may be cut consecutively from the third lamination strip as alternate upright and inverted trapezoids.

At block 612, the first side limb component, the second side limb component, the intermediate limb component, the upper yoke component, and the lower yoke component are joined to form a lamination layer of a transformer core.

In one example, a lamination layer of the transformer core may be formed by adjoining the first intermediate limb segment and the second intermediate limb segment along a base of the first and second intermediate limb segment to form the intermediate limb component. Further, a first diagonal edge of a first upper yoke segment may be adjoined to a first slanting edge of the first intermediate limb segment of the intermediate limb component and a first diagonal edge of a second upper yoke segment may be adjoined to a first slanting edge of the second intermediate limb segment of the intermediate limb component at a first end of the intermediate limb component. Similarly, a first diagonal edge of a first lower yoke segment may be adjoined to a second slanting edge of the first intermediate limb segment of the intermediate limb component and a first diagonal edge of a second lower yoke segment may be adjoined to a second slanting edge of the second intermediate limb segment of the intermediate limb component at a second end of the intermediate limb component. Further, a first abutting edge of the first side limb component may be adjoined to a second diagonal edge of the first upper yoke segment at an upper end of the first side limb component and a second abutting edge of the first side limb component may be adjoined to a second diagonal edge of the first lower yoke segment at a lower end of the first side limb component. Similarly, a first abutting edge of the second side limb component may be adjoined to a second diagonal edge of the second upper yoke segment at an upper end of the second side limb component and a second abutting edge of the second side limb component may be adjoined to a second diagonal edge of the second lower yoke segment at a lower end of the second side limb component.

In one example, the plurality of upper yoke segments may be formed by cutting the first lamination strip into a trapezoidal structure such that the first diagonal edge of an upper yoke segment makes a first upper yoke angle with the base of the corresponding upper yoke segment and the second diagonal edge of the upper yoke segment makes a second upper yoke angle with the base of the corresponding upper yoke segment. In one example, the first upper yoke angle of the upper yoke segment may range between 55 degrees to 70 degrees and the second upper yoke angle may be a 45-degree angle. Similarly, the plurality of lower yoke segments may be formed by cutting a second lamination strip into a trapezoidal structure such that the first diagonal edge of the a lower yoke segment makes a first lower yoke angle with the base of the corresponding lower yoke segment and the second diagonal edge of the lower yoke segment makes a second lower yoke angle with the base of the corresponding lower yoke segment. In one example, the first lower yoke angle of the plurality of lower yoke segments, may range between 55 degrees to 70 degrees and the second lower angle may be a 45-degree angle.

In one example, the plurality of lamination layers may be stacked to form the transformer core, where two consecutive lamination layers of the plurality of lamination layers may be stacked with a predetermined offset between adjacent layers forming a step-lap joint. The dimensions of the plurality of lower yoke segments and dimensions of the first intermediate limb segments and the second intermediate limb segments may be a function of the predetermined offset. In one example, stacking of the transformer core may be performed by placing three lamination layers to the right of a first side limb component axis and three lamination layers to the left of the first side limb component axis to form the step-lap joint.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

1. A transformer core comprising:
a plurality of lamination layers, at least one lamination layer of the plurality of lamination layers comprising:
a first side limb component;
a second side limb component;
an upper yoke component disposed in between an upper end of the first side limb component and an upper end of the second side limb component, the upper yoke component comprising one or more upper yoke segment;
a lower yoke component disposed in between a lower end of the first side limb component and a lower end of the second side limb component, the lower yoke component comprising one or more lower yoke segments; and
an intermediate limb component comprising a first intermediate limb segment and a second intermediate limb segment, wherein a first end of the intermediate limb component is disposed in between two consecutive upper yoke segments and a second end of the intermediate limb component is disposed in between two consecutive lower yoke segments,
at least one of the upper yoke segment and the lower yoke segment being trapezoidal in structure.

2. The transformer core as claimed in claim 1, wherein the upper yoke component comprises a plurality of upper yoke segments and the lower yoke component comprises a plurality of lower yoke segments, wherein
a first diagonal edge of each of the plurality of upper yoke segments makes a first upper yoke angle with a base of the corresponding upper yoke segment, wherein the first upper yoke angle ranges between 55 degrees to 70 degrees;
a second diagonal edge of each of the plurality of upper yoke segments makes a second upper yoke angle with a base of the corresponding upper yoke segment, wherein the second upper yoke angle is a 45-degree angle;
a first diagonal edge of each of the plurality of lower yoke segments makes a first lower yoke angle with a base of the corresponding lower yoke segment, wherein the first lower yoke angle ranges between 55 degrees to 70 degrees; and
a second diagonal edge of each of the plurality of lower yoke segments makes a second lower yoke angle with a base of the corresponding lower yoke segment, wherein the second lower yoke angle is a 45-degree angle.

3. The transformer core as claimed in claim 2, wherein
a first slanting edge of the first intermediate limb segment is adjoined to a first diagonal edge of a first upper yoke segment and a first slanting edge of the second intermediate limb segment is adjoined to a first diagonal edge of a second upper yoke segment at a first end of the intermediate limb component;
a second slanting edge of the first intermediate limb segment is adjoined to a first diagonal edge of a first lower yoke segment and a second slanting edge of the second intermediate limb segment is adjoined to a first diagonal edge of a second lower yoke segment at a second end of the intermediate limb component;
a first abutting edge of the first side limb component is adjoined to a second diagonal edge of the first upper yoke segment at an upper end of the first side limb component and a second abutting edge of first side limb component is adjoined to a second diagonal edge of the first lower yoke segment at a lower end of the first side limb component; and
a first abutting edge of the second side limb component is adjoined to a second diagonal edge of the second upper yoke segment at an upper end of the second side limb component and a second abutting edge of the second side limb component is adjoined to a second diagonal edge of the second lower yoke segment at a lower end of the second side limb component.

4. The transformer core as claimed in claim 1, wherein a length of the base of the first intermediate limb segment and the second intermediate limb segment of the intermediate limb component is equal to a length of a base of the first side limb component and a length of a base of the second side limb component, wherein each of the first intermediate limb segment, second intermediate limb segment, first side limb component, and second side limb component are trapezoidal in structure.

5. The transformer core as claimed in claim 1, wherein the first intermediate limb segment and the second intermediate limb segment are adjoined along respective bases to form the intermediate limb component.

6. The transformer core as claimed in claim 1, wherein two consecutive lamination layers of the plurality of lamination layers are stacked with a predetermined offset between adjacent layers to form a step-lap joint.

7. The transformer core as claimed in claim 6, wherein lengths of a first lower yoke segment and a second lower yoke segment of a lamination layer are respectively different from lengths of a successive first lower yoke segment and a successive second lower yoke segment of a successive lamination layer.

8. The transformer core as claimed in claim 1, wherein widths of the first intermediate limb segment and the second intermediate limb segment of the intermediate limb component of a lamination layer are respectively different from widths of a successive first intermediate limb segment and a successive second intermediate limb segment of the intermediate limb component of a successive lamination layer.

9. The transformer core as claimed in claim 3, wherein
the first slanting edge and the second slanting edge of the first intermediate limb segment makes a first intermediate angle and a second intermediate angle with the base of the first limb segment, respectively, wherein the first intermediate angle and the second intermediate angle ranges between 20 degrees to 35 degrees; and
the first slanting edge and the second slanting edge of the second intermediate limb segment makes a first intermediate angle and a second intermediate angle with the base of the second limb segment, respectively, wherein the first intermediate angle and the second intermediate angle ranges between 20 degrees to 35 degrees.

10. A method of forming a transformer core, comprising:
obtaining a first side limb component;
obtaining a second side limb component;
cutting a first lamination strip to obtain a plurality of upper yoke segments that are trapezoidal in structure to form an upper yoke component, wherein the plurality of the upper yoke segments are cut consecutively from the first lamination strip as alternate upright and inverted trapezoids, and disposing the upper yoke component between an upper end of the first side limb component and an upper end of the second side limb component;
cutting a second lamination strip to obtain a plurality of lower yoke segments that are trapezoidal in structure to form a lower yoke component, wherein the plurality of the lower yoke segments are cut consecutively from the second lamination strip as alternate upright and inverted trapezoids, and disposing the lower yoke component between a lower end of the first side limb component and a lower end of the second side limb component;
forming an intermediate limb component from a first intermediate limb segment and a second intermediate limb segment and disposing a first end of the intermediate limb component between two consecutive upper yoke segments and a second end of the intermediate limb component between two consecutive lower yoke segments; and
joining the first side limb component, the second side limb component, the intermediate limb component, the upper yoke component, and the lower yoke component to form a lamination layer of a transformer core.

11. The method as claimed in claim 10, comprising cutting a third lamination strip to obtain first intermediate limb segments and second intermediate limb segments that are trapezoidal in structure to form the intermediate limb component, wherein the first intermediate limb segments and the second intermediate limb segments are cut consecutively from the third lamination strip as alternate upright and inverted trapezoids.

12. The method as claimed in claim 11, wherein
a first diagonal edge of each of the plurality of upper yoke segments makes a first upper yoke angle with a base of the corresponding upper yoke segment, wherein the first upper yoke angle is based on a length of the corresponding upper yoke segment, wherein the first upper yoke angle ranges between 55 degrees to 70 degrees;
a second diagonal edge of each of the plurality of upper yoke segments makes a second upper yoke angle with a base of the corresponding upper yoke segment, wherein the second upper yoke angle is a 45-degree angle;
a first diagonal edge of each of the plurality of lower yoke segments makes a first lower yoke angle with a base of the corresponding lower yoke segment, wherein the first lower yoke angle is based on a length of the corresponding lower yoke segment; ranges between 55 degrees to 70 degrees; and
a second diagonal edge of each of the plurality of lower yoke segments makes a second lower yoke angle with a base of the corresponding lower yoke segment, wherein the second lower yoke angle is a 45-degree angle.

13. The method as claimed in claim 11, comprising
stacking a plurality of lamination layers to form the transformer core, wherein two consecutive lamination layers of the plurality of lamination layers are stacked with a predetermined offset between adjacent layers forming a step-lap joint.

14. The method as claimed in claim 13, wherein dimensions of the plurality of lower yoke segments and dimensions of the first intermediate limb segments and the second intermediate limb segments are a function of the predetermined offset.

15. The method as claimed in claim 10, comprising
adjoining the first intermediate limb segment and the second intermediate limb segment along a base of the first and second intermediate limb segments to form the intermediate limb component;
adjoining a first diagonal edge of a first upper yoke segment to a first slanting edge of the first intermediate limb segment and adjoining a first diagonal edge of a second upper yoke segment to a first slanting edge of the second intermediate limb segment at a first end of the intermediate limb component;
adjoining a first diagonal edge of a first lower yoke segment to a second slanting edge of the first intermediate limb segment and adjoining a first diagonal edge of a second lower yoke segment to a second slanting edge of the second intermediate limb segment at a second end of the intermediate limb component;
adjoining a first abutting edge of the first side limb component to a second diagonal edge of the first upper yoke segment at an upper end of the first side limb component and adjoining a second abutting edge of the first side limb component to a second diagonal edge of the first lower yoke segment at a lower end of the first side limb component; and
adjoining a first abutting edge of the second side limb component to a second diagonal edge of the second upper yoke segment at an upper end of the second side limb component and adjoining a second abutting edge of the second side limb component to a second diagonal edge of the second lower yoke segment at a lower end of the second side limb component.

16. A transformer comprising:
a transformer core comprising:
a plurality of lamination layers, at least one lamination layer of the plurality of lamination layers comprising:
a first side limb component;
a second side limb component;
an upper yoke component disposed in between an upper end of the first side limb component and an upper end of the second side limb component, the upper yoke component comprising one or more upper yoke segment;
a lower yoke component disposed in between a lower end of the first side limb component and a lower end of the second side limb component, the lower yoke component comprising one or more lower yoke segments; and
an intermediate limb component comprising a first intermediate limb segment and a second intermediate limb segment, wherein a first end of the intermediate limb component is disposed in between two consecutive upper yoke segments and a second end of the intermediate limb component is disposed in between two consecutive lower yoke segments,
at least one of the upper yoke segment and the lower yoke segment being trapezoidal in structure; and
a plurality of windings wound on the transformer core.

17. The transformer as claimed in claim 16, wherein the upper yoke component comprises a plurality of upper yoke segments and the lower yoke component comprises a plurality of lower yoke segments, wherein
a first diagonal edge of each of the plurality of upper yoke segments makes a first upper yoke angle with a base of the corresponding upper yoke segment, wherein the first upper yoke angle ranges between 55 degrees to 70 degrees;
a second diagonal edge of each of the plurality of upper yoke segments makes a second upper yoke angle with a base of the corresponding upper yoke segment, wherein the second upper yoke angle is a 45-degree angle;
a first diagonal edge of each of the plurality of lower yoke segments makes a first lower yoke angle with a base of the corresponding lower yoke segment, wherein the first lower yoke angle ranges between 55 degrees to 70 degrees; and
a second diagonal edge of each of the plurality of lower yoke segments makes a second lower yoke angle with a base of the corresponding lower yoke segment, wherein the second lower yoke angle is a 45-degree angle.

18. The transformer as claimed in claim 17, wherein
a first slanting edge of the first intermediate limb segment is adjoined to a first diagonal edge of a first upper yoke segment and a first slanting edge of the second intermediate limb segment is adjoined to a first diagonal edge of a second upper yoke segment at a first end of the intermediate limb component;
a second slanting edge of the first intermediate limb segment is adjoined to a first diagonal edge of a first lower yoke segment and a second slanting edge of the second intermediate limb segment is adjoined to a first diagonal edge of a second lower yoke segment at a second end of the intermediate limb component;
a first abutting edge of the first side limb component is adjoined to a second diagonal edge of the first upper yoke segment at an upper end of the first side limb component and a second abutting edge of first side limb component is adjoined to a second diagonal edge of the first lower yoke segment at a lower end of the first side limb component; and
a first abutting edge of the second side limb component is adjoined to a second diagonal edge of the second upper yoke segment at an upper end of the second side limb component and a second abutting edge of the second side limb component is adjoined to a second diagonal edge of the second lower yoke segment at a lower end of the second side limb component.

19. The transformer as claimed in claim 16, wherein a length of the base of the first intermediate limb segment and the second intermediate limb segment of the intermediate limb component is equal to a length of a base of the first side limb component and a length of a base of the second side limb component, wherein each of the first intermediate limb segment, second intermediate limb segment, first side limb component, and second side limb component are trapezoidal in structure.

20. The transformer as claimed in claim 17, wherein the first intermediate limb segment and the second intermediate limb segment are adjoined along respective bases to form the intermediate limb component.
